(19) United States
(12) Patent Application Publication
(10) Pub. No.: US 2019/0219537 A1
(43) Pub. Date: Jul. 18, 2019

(54) CONTROL DEVICE

(71) Applicant: DENSO CORPORATION, Kariya-city (JP)

(72) Inventors: Shoki SHIMIZU, Kariya-city (JP); Ryozo KAYAMA, Kariya-city (JP); Tadakatsu KOYABU, Kariya-city (JP); Yuki MURAYAMA, Kariya-city (JP)

(21) Appl. No.: 16/250,151

(22) Filed: Jan. 17, 2019

(30) Foreign Application Priority Data
Jan. 18, 2018 (JP) 2018-006060

(51) Int. Cl. G01N 27/416; F02D 41/22; F02D 41/14; G01M 15/10; G01N 27/41; G05B 19/042

(52) U.S. Cl. CPC G01N 27/4163; F02D 41/222; F02D 41/1488; G05B 19/042; G01M 15/102; G01N 27/41; F02D 41/146

(57) ABSTRACT

In a control device for an exhaust gas sensor, a deterioration determination section determines whether the magnitude of a signal outputted from a second cell has exceeded a threshold to thereby determine whether a first cell has deteriorated. A threshold setting section variably sets the threshold depending on a concentration of the oxygen in the exhaust gas.

### CROSS-REFERENCE TO RELATED APPLICATION

This application is based on and claims the benefit of priority from earlier Japanese Patent Application No. 2018-006060 filed on Jan. 18, 2018, the description of which is incorporated herein by reference.

### TECHNICAL FIELD

The present disclosure relates to a control device for an exhaust gas sensor.

### BACKGROUND

A control device is known to control an exhaust gas sensor provided in, for example, an exhaust pipe of a vehicle including an internal combustion engine.

### SUMMARY

According to an exemplary aspect of the present disclosure, there is provided a control device for an exhaust gas sensor. The control device includes a deterioration determination section determines whether the magnitude of a signal outputted from a second cell has exceeded a threshold to thereby determine whether a first cell has deteriorated. The control device includes a threshold setting section variably sets the threshold depending on a concentration of the oxygen in the exhaust gas.

### BRIEF DESCRIPTION OF THE DRAWINGS

Other aspects of the present disclosure will become apparent from the following description of embodiments with reference to the accompanying drawings in which:

FIG. 1 is an overall structural diagram schematically illustrating an exhaust system of a vehicle including exhaust gas sensors and a control device are provided according to the first embodiment of the present disclosure;

FIG. 2 is a structural diagram schematically illustrating the structure of an exhaust gas sensor and the structure of the control device according to the first embodiment;

FIG. 3 is a cross sectional view taken upon line III-III of FIG. 2;

FIG. 4 is a perspective view schematically describing a measurement principal of the exhaust gas sensor according to the first embodiment;

FIG. 5 is a graph schematically illustrating an example of a method of obtaining a temperature of a pump cell according to the first embodiment;

FIGS. 6(A) and 6(B) are a joint timing chart schematically illustrating a deterioration determination method according to the first embodiment;

FIG. 7 is a flowchart schematically illustrating a series of processes executed by the control device according to the first embodiment;

FIG. 8 is a graph schematically illustrating an example of a relationship between the concentration of oxygen in an exhaust gas and a threshold according to the first embodiment;

FIG. 9 is a flowchart schematically illustrating a series of processes executed by the control device according to a modification of the first embodiment;

FIGS. 10(A) and 10(B) are a joint timing chart schematically illustrating a deterioration determination method according to the second embodiment of the present disclosure;

FIG. 11 is a flowchart schematically illustrating a series of processes executed by the control device according to the second embodiment;

FIG. 12 is a flowchart schematically illustrating a series of processes executed by the control device according to the second embodiment;

FIG. 13 is a flowchart schematically illustrating a series of processes executed by the control device according to the third embodiment of the present disclosure; and

FIG. 14 is a flowchart schematically illustrating a series of processes executed by the control device according to the second embodiment.

### DETAILED DESCRIPTION OF EMBODIMENT INVENTOR'S VIEWPOINT

An exhaust pipe of a vehicle including an internal combustion engine is provided with an exhaust gas sensor for measuring the concentration of a specific gas (e.g., nitrogen oxides) contained in an exhaust gas. Known examples of such an exhaust gas sensor include an exhaust gas sensor including a plurality of cells in each of which electrodes are provided on both sides of a solid electrolyte layer. While a voltage is being applied between the electrodes of each cell, the cell outputs a signal (e.g., an electric current) having a magnitude corresponding to the concentration of a gas component to be measured.

For example, a known exhaust gas sensor includes, as such plurality of cells, an oxygen pump cell, an oxygen generation cell, and an oxygen concentration detection cell. The exhaust gas sensor is configured such that oxygen contained in an exhaust gas is discharged in advance by the oxygen pump cell arranged on an upstream side of the exhaust gas. In the oxygen generation cell arranged on a downstream side of the exhaust gas relative to the oxygen pump cell, nitrogen oxides contained in the exhaust gas from which oxygen has been discharged are decomposed. During the decomposition process, the concentration of nitrogen oxides contained in the exhaust gas is detected on the basis of a signal outputted from the oxygen concentration detection cell arranged on the downstream side of the exhaust gas relative to the oxygen pump cell. The exhaust gas sensor having such a configuration discharges, from an exhaust gas, oxygen, whose amount is larger than nitrogen oxides, to thereby accurately measure the concentration of the nitrogen oxides.

In the exhaust gas sensor having the above configuration, a cell arranged on the upstream side of the exhaust gas may deteriorate, resulting in reduction of the capacity of the cell to discharge oxygen. A decrease in the oxygen discharge capacity of the cell arranged on the upstream side of the exhaust gas causes a large amount of oxygen to reach cells arranged on the relatively downstream side of the exhaust gas, resulting in reduction in the accuracy of detecting nitrogen oxides.

For addressing such an issue, there is known a failure diagnosis device applies a specific voltage to an oxygen pump cell arranged on the upstream side of an exhaust gas when the concentration of oxygen in the exhaust gas has a known specific value. Then, the failure diagnosis device determines that the oxygen pump cell has deteriorated upon determining that the magnitude of a signal outputted from the oxygen pump cell deviates from a normal value.

The magnitude of the signal outputted from the oxygen pump cell while a voltage is being applied to the oxygen pump cell varies depending on the concentration of oxygen in the exhaust gas. Thus, in order to determine, based on the signal outputted from the oxygen pump cell, whether the oxygen pump cell has deteriorated, the concentration of oxygen in the exhaust gas needs to be known and have a specific value as described above.

However, determination of whether the oxygen pump cell has deteriorated is preferably not limitedly performed only in such a specific situation, but is performed at a high frequency in various situations.

From the above viewpoint, the following describes embodiments of the present disclosure with reference to the accompanying drawings. In the embodiments, like parts between the embodiments, to which like reference characters are assigned, are omitted or simplified to avoid redundant description.

### First Embodiment

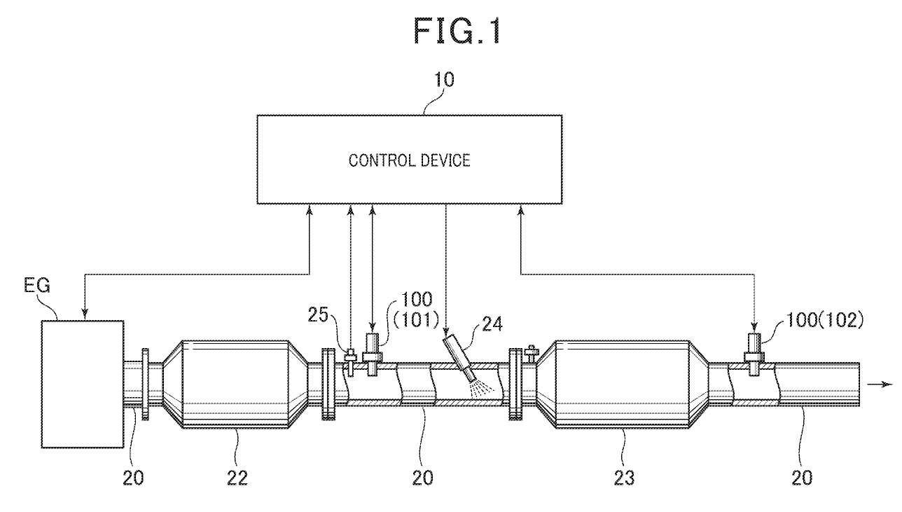

A control device 10 according to the first embodiment is a device for controlling exhaust gas sensors 100. FIG. 1 schematically illustrates an exhaust system of a vehicle including the exhaust gas sensors 100. As illustrated in FIG. 1, an exhaust pipe 20 is connected to an internal combustion engine EG of the vehicle. The exhaust pipe 20 guides exhaust gas emitted from the internal combustion engine EG to an outside. The exhaust gas sensors 100 are each a sensor for measuring a concentration of nitrogen oxides contained in the exhaust gas, and are provided at a plurality of intermediate positions in the exhaust pipe 20.

An oxidation catalytic converter 22 and an SCR catalytic converter 23 are provided at respective intermediate positions in the exhaust pipe 20.

The oxidation catalytic converter 22 is a device that purifies harmful substances from the exhaust gas. An oxidation catalyst (not illustrated) is housed inside the oxidation catalytic converter 22. The oxidation catalyst is mainly composed of a carrier made of ceramic, an oxide mixture containing an aluminum oxide, cerium dioxide, and a zirconium dioxide, and a noble metal catalyst such as platinum, palladium, or rhodium. The oxidation catalyst oxidizes hydrocarbon, carbon monoxide, nitrogen oxides, and the like contained in the exhaust gas, and purifies these substances from the exhaust gas. In addition to the oxidation catalyst, a particulate filter for capturing fine particles may be housed inside the oxidation catalytic converter 22.

The SCR catalytic converter 23 is a device that further purifies the exhaust gas that has passed through the oxidation catalytic converter 22. A selective reduction catalyst (not illustrated) is housed inside the SCR catalytic converter 23. As the selective reduction catalyst, a catalyst is used in which a noble metal such as Pt is supported on a surface of a substrate made of zeolite, alumina, or the like. The catalyst reduces nitrogen oxides and purifies the nitrogen oxides from the exhaust gas, when a temperature of the catalyst is within an active temperature range, and urea as a reducing agent has been added to the catalyst. A urea addition injector 24 for adding urea is provided at a position upstream of the SCR catalytic converter 23 in the exhaust pipe 20.

In the present embodiment, the exhaust pipe 20 is provided with two exhaust gas sensors 100 to be controlled by the control device 10. One of the exhaust gas sensors 100 (indicated by reference sign 101 in FIG. 1) is provided at a position between the oxidation catalytic converter 22 and the SCR catalytic converter 23 in the exhaust pipe 20, and measures a concentration of nitrogen oxides in the exhaust gas at this position. The other of the exhaust gas sensors 100 (indicated by reference sign 102 in FIG. 1) is provided at a position downstream of the SCR catalytic converter 23 in the exhaust pipe 20, and measures a concentration of nitrogen oxides in the exhaust gas at this position.

The concentrations of nitrogen oxides measured by the respective exhaust gas sensors 100 are transmitted to the control device 10. The control device 10 performs various types of control of the internal combustion engine EG on the basis of the concentrations of nitrogen oxides. Examples of such control include control for adjusting ignition timing and control for adjusting an amount of fuel to be injected in the internal combustion engine EG, and control for adjusting an amount of urea to be added by the urea addition injector 24.

Thus, the control device 10 according to the present embodiment is configured as a device that controls not only the exhaust gas sensor 100 (described later) but also the internal combustion engine EG. That is, the control device 10 also has a function as what is called an “engine ECU”. Alternatively, the control device 10 may be configured as a dedicated device for controlling the exhaust gas sensor 100, i.e., a control device different from the engine ECU. In such a case, the control device 10 communicates with the engine ECU to contribute to control of the internal combustion engine EG performed by the engine ECU.

Other configurations will be described. A gas temperature sensor 25 is provided at a position between the oxidation catalytic converter 22 and the SCR catalytic converter 23 in the exhaust pipe 20. The gas temperature sensor 25 is a sensor for measuring a temperature of the exhaust gas in the vicinity of the exhaust gas sensors 100. The temperature of the exhaust gas measured by the gas temperature sensor 25 is transmitted to the control device 10. A gas temperature sensor similar to the gas temperature sensor 25 may further be provided at a position downstream of the SCR catalytic converter 23 in the exhaust pipe 20.

The two exhaust gas sensors 100 in FIG. 1 have the same configuration. Furthermore, for the two exhaust gas sensors 100, the control device 10 performs the same control for measurement of the concentration of nitrogen oxides, deterioration determination, and the like. Thus, the configuration and the like of only one (indicated by reference sign 101) of the exhaust gas sensors 100 will be described below, and description of those of the other (indicated by reference sign 102) of the exhaust gas sensors 100 will be omitted.

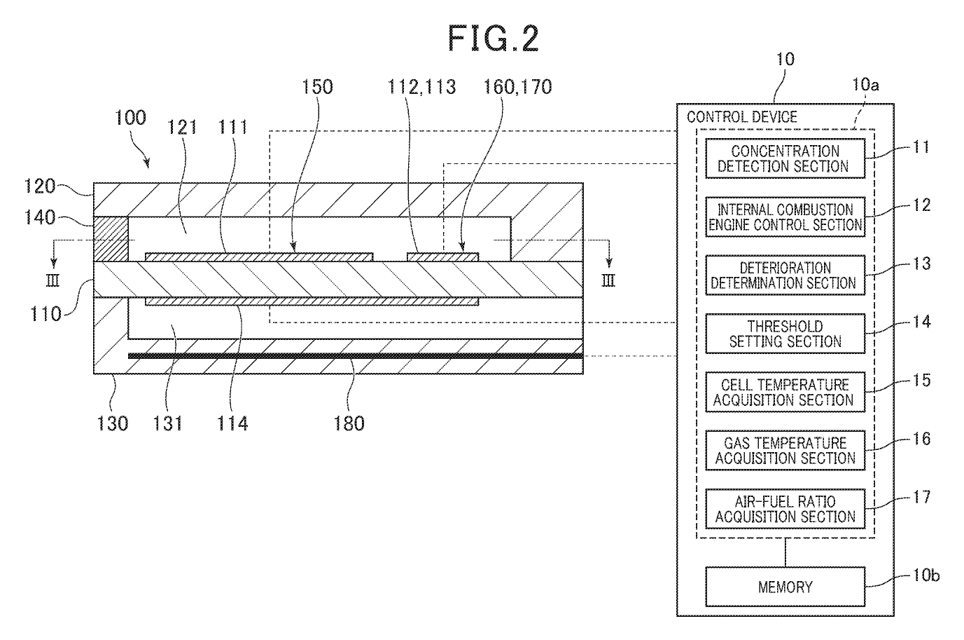

A specific configuration of the exhaust gas sensor 100 will be described with reference to FIGS. 2 to 4. FIG. 2 schematically illustrates a cross section of a portion of the exhaust gas sensor 100 provided inside the exhaust pipe 20. A left end portion in FIG. 2 corresponds to a tip portion of the exhaust gas sensor 100 protruding inside the exhaust pipe 20.

The exhaust gas sensor 100 includes a solid electrolyte 110 and body portions 120 and 130.

The solid electrolyte 110 is a plate-shaped member, and is composed of a solid electrolyte material such as zirconia oxide. When the solid electrolyte 110 is in an active state at a predetermined temperature or higher, the solid electrolyte 110 has oxygen ionic conductivity. A plurality of cells, i.e., a pump cell 150, a sensor cell 160, and a monitor cell 170, are provided on the solid electrolyte 110. These cells will be described later.

The body portions 120 and 130 are each a plate-shaped member, and are composed of an insulation material whose main component is alumina. The body portions 120 and 130 are arranged so as to sandwich the solid electrolyte 110 therebetween. The body portion 120 is arranged on one side of the solid electrolyte 110. A portion of a surface of the body portion 120 closer to the solid electrolyte 110 is recessed away from the solid electrolyte 110. Thus, a space is provided between the body portion 120 and the solid electrolyte 110. Exhaust gas to be measured is introduced into the space. The space is also termed a “measurement chamber 121” hereinafter.

A diffusion resistor 140 is provided at the tip portion of the exhaust gas sensor 100. The measurement chamber 121 is open to an outside of the exhaust gas sensor 100 (i.e., an inside of the exhaust pipe 20) through the diffusion resistor 140. The diffusion resistor 140 is composed of a ceramic material such as alumina which is porous or has pores. An amount of exhaust gas introduced into the measurement chamber 121 is controlled by an action of the diffusion resistor 140. The exhaust gas flowing into the measurement chamber 121 through the diffusion resistor 140 is supplied to the pump cell 150, the sensor cell 160, and the monitor cell 170 (described later).

The body portion 130 is arranged on the other side of the solid electrolyte 110. A portion of a surface of the body portion 130 closer to the solid electrolyte 110 is recessed away from the solid electrolyte 110. Thus, a space is provided also between the body portion 130 and the solid electrolyte 110. Part (not illustrated) of the space is open to air outside the exhaust pipe 20. That is, air is introduced into the space. The space is also termed an “air chamber 131” hereinafter.

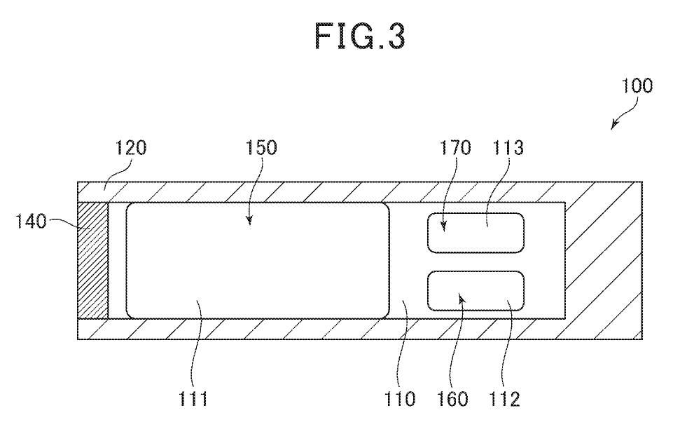

A pump electrode 111, a sensor electrode 112, and a monitor electrode 113 are provided on a surface of the solid electrolyte 110 in contact with the measurement chamber 121. The pump electrode 111 is provided at a position on the solid electrolyte 110 closer to the diffusion resistor 140. The sensor electrode 112 and the monitor electrode 113 are provided at respective positions on the solid electrolyte 110 on a side opposite to the diffusion resistor 140 such that the pump electrode 111 is provided between the diffusion resistor 140 and each of the sensor electrode 112 and the monitor electrode 113. The sensor electrode 112 and the monitor electrode 113 are arranged along a depth direction of the page in FIG. 2 (see FIG. 3).

The pump electrode 111 and the monitor electrode 113 are composed of a Pt—Au alloy (platinum-gold alloy). The pump electrode 111 and the monitor electrode 113 are each an electrode that is active to oxygen and is inactive to nitrogen oxides. On the other hand, the sensor electrode 112 is composed of a noble metal such as Pt (platinum) or Rh (rhodium), and is an electrode that is active to oxygen and is also active to nitrogen oxides.

A common electrode 114 is provided on a surface of the solid electrolyte 110 in contact with the air chamber 131. The common electrode 114 is provide in a range overlapping all the pump electrode 111, the sensor electrode 112, and the monitor electrode 113 when viewed from a direction perpendicular to the solid electrolyte 110 as in FIG. 3. The common electrode 114 is composed of a material whose main component is Pt (platinum).

When a voltage is applied between the pump electrode 111 and the common electrode 114 while the solid electrolyte 110 is in an active state at a high temperature, oxygen contained in the exhaust gas in the measurement chamber 121 is decomposed into oxygen ions at the pump electrode 111, and the oxygen ions pass through the solid electrolyte 110. Thus, oxygen is discharged from the measurement chamber 121 into the air chamber 131. Specifically, a portion where the solid electrolyte 110 is sandwiched between the pump electrode 111 and the common electrode 114 functions as the pump cell 150 for discharging oxygen from the exhaust gas. The pump cell 150 corresponds to a “first cell” of the present embodiment.

While oxygen is being discharged as described above, an electric current flows between the pump electrode 111 and the common electrode 114. A value of the electric current is a value that is proportional to an amount of oxygen discharged from the exhaust gas and is proportional to a concentration of oxygen in the exhaust gas. That is, the pump cell 150 outputs a signal (the electric current) corresponding to the concentration of oxygen in the exhaust gas. On the basis of the value of the electric current, the control device 10 (described later) obtains the concentration of oxygen in the exhaust gas in the measurement chamber 121.

When a voltage is applied between the sensor electrode 112 and the common electrode 114 while the solid electrolyte 110 is in an active state at a high temperature, oxygen and nitrogen oxides contained in the exhaust gas in the measurement chamber 121 are both decomposed into oxygen ions at the sensor electrode 112, and the oxygen ions pass through the solid electrolyte 110. Thus, an electric current corresponding to a concentration of oxygen and nitrogen oxides in the vicinity of the sensor electrode 112 flows between the sensor electrode 112 and the common electrode 114. A value of the electric current is acquired by the control device 10.

Specifically, a portion where the solid electrolyte 110 is sandwiched between the sensor electrode 112 and the common electrode 114 functions as the sensor cell 160 that outputs a signal (the electric current) whose magnitude corresponds to, i.e. depends on, a concentration of residual oxygen and nitrogen oxides contained in the exhaust gas, while a voltage is being applied to the sensor cell 160. The exhaust gas whose concentration of nitrogen oxides and residual oxygen is measured by the sensor cell 160 is the exhaust gas from which oxygen has been discharged by the pump cell 150. The sensor cell 160 corresponds to one of “second cells” of the present embodiment.

When a voltage is applied between the monitor electrode 113 and the common electrode 114 while the solid electrolyte 110 is in an active state at a high temperature, oxygen contained in the exhaust gas in the measurement chamber 121 is decomposed into oxygen ions at the monitor electrode 113, and the oxygen ions pass through the solid electrolyte 110. Thus, an electric current corresponding to a concentration of oxygen in the vicinity of the monitor electrode 113 flows between the monitor electrode 113 and the common electrode 114. A value of the electric current is acquired by the control device 10.

Specifically, a portion where the solid electrolyte 110 is sandwiched between the monitor electrode 113 and the common electrode 114 functions as the monitor cell 170 that outputs a signal (the electric current) whose magnitude corresponds to a concentration of residual oxygen contained in the exhaust gas. The exhaust gas whose concentration of residual oxygen is measured by the monitor cell 170 is the exhaust gas from which oxygen has been discharged by the pump cell 150. The monitor cell 170 corresponds to one of the “second cells” of the present embodiment, as with the sensor cell 160 mentioned above.

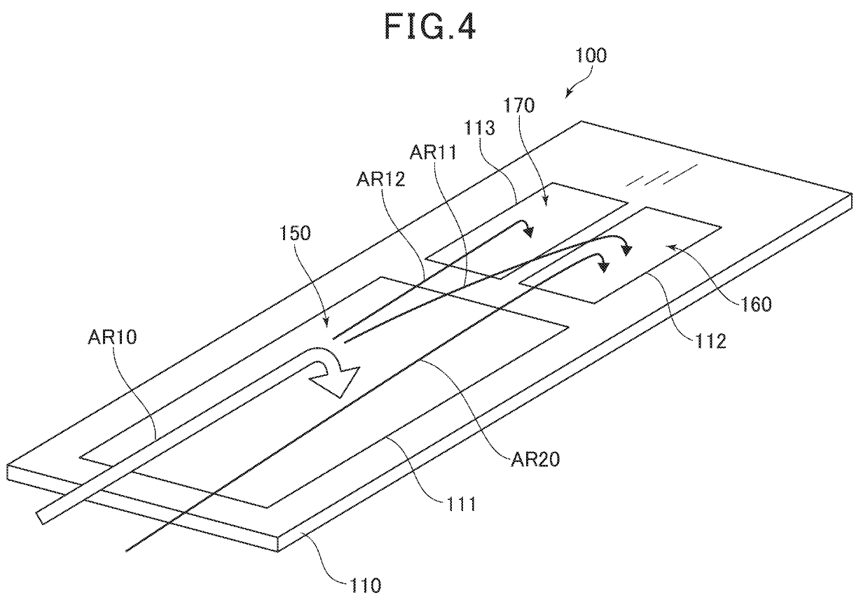

The exhaust gas flowing into the measurement chamber 121 through the diffusion resistor 140 flows along the pump cell 150, and is then supplied to each of the sensor cell 160 and the monitor cell 170. FIG. 4 schematically shows such flows of the exhaust gas with a plurality of arrows. An arrow AR10 indicates a flow of oxygen that flows into the measurement chamber 121 through the diffusion resistor 140 and is then discharged by the pump cell 150. Most of the oxygen contained in the exhaust gas is removed by the pump cell 150. However, it is difficult to completely remove the oxygen. Thus, a slight amount of oxygen reaches each of the sensor cell 160 and the monitor cell 170. An arrow AR11 indicates a flow of oxygen reaching the sensor cell 160, and an arrow AR12 indicates a flow of oxygen reaching the monitor cell 170.

As already mentioned, the pump electrode 111 and the monitor electrode 113 are each an electrode inactive to nitrogen oxides. Accordingly, nitrogen oxides contained in the exhaust gas flowing into the measurement chamber 121 is not discharged by the pump cell 150 or the monitor cell 170, and directly reaches the sensor electrode 112 of the sensor cell 160. An arrow AR20 indicates such a flow of nitrogen oxides reaching the sensor cell 160.

As illustrated in FIG. 4, the nitrogen oxides (arrow AR20) and the residual oxygen (arrow AR11) both reach the sensor cell 160. Accordingly, a magnitude of an output current from the sensor cell 160 indicates a concentration of nitrogen oxides and oxygen contained in the exhaust gas.

On the other hand, a magnitude of an output current from the monitor cell 170 indicates a concentration of oxygen contained in the exhaust gas. Accordingly, a current value obtained by subtracting the output current of the monitor cell 170 from the output current of the sensor cell 160 indicates a concentration of only nitrogen oxides. Thus, the exhaust gas sensor 100 can accurately measure a concentration of nitrogen oxides by reducing an influence of oxygen contained in the exhaust gas.

As illustrated in FIG. 2, a heater 180 is embedded in the body portion 130. The heater 180 generates heat inside the body portion 130 and heats each of the pump cell 150, the sensor cell 160, and the monitor cell 170. The heater 180 maintains a temperature at which the solid electrolyte 110 is active. An output of (an amount of heat generated by) the heater 180 is adjusted by the control device 10.

The configuration of the control device 10 will be continuously described with reference to FIG. 2. The control device 10 is constituted as a computer system including a processor, such as a CPU, 10a and a memory 10b including a ROM, a RAM, and/ or the like. At least part of all functions provided by the control device 10 can be implemented by at least one processor; the at least one processor can be comprised of

(1) The combination of at least one programmable processing unit, i.e. at least one programmable logic circuit, and at least one memory

(2) At least one hardwired logic circuit

(3) At least one hardwired-logic and programmable-logic hybrid circuit

Specifically, the control device 10 is configured such that the CPU 10a performs instructions of programs stored in the memory 10b, thus performing predetermined software tasks associated with the hybrid vehicle. The control device 10 can also be configured such that the at least one special-purpose electronic circuit performs predetermined hardware tasks associated with the exhaust gas sensor 100. The control device 10 can be configured to perform both the software tasks and the hardware tasks.

Specifically, the control device 10 includes, as functional control blocks, a concentration detection section 11, an internal combustion engine control section 12, a deterioration determination section 13, a threshold setting section 14, a cell temperature acquisition section 15, a gas temperature acquisition section 16, and an air-fuel ratio acquisition section 17.

The concentration detection section 11 is a section that detects a concentration of nitrogen oxides contained in the exhaust gas on the basis of a signal (an electric current in the present embodiment) outputted from each of the monitor cell 170 and the sensor cell 160. As already mentioned, the concentration detection section 11 detects the concentration of nitrogen oxides on the basis of a current value obtained by subtracting the output current of the monitor cell 170 from the output current of the sensor cell 160.

The internal combustion engine control section 12 is a section that controls the internal combustion engine EG on the basis of the concentration of nitrogen oxides detected by the concentration detection section 11. The internal combustion engine control section 12 adjusts the amount of fuel to be injected in the internal combustion engine EG and the like so that the detected concentration of nitrogen oxides becomes closer to zero. As already mentioned, the control device 10 may be configured as a dedicated device for controlling the exhaust gas sensor 100, i.e., a control device different from the engine ECU. In such a case, the internal combustion engine control section 12 is constituted as a part of the engine ECU.

The deterioration determination section 13 is a section that determines whether the pump cell 150 has deteriorated. When the pump cell 150 deteriorates, the pump cell 150 cannot sufficiently discharge oxygen in advance from the exhaust gas, and this causes a large amount of oxygen to reach the monitor cell 170 and the sensor cell 160 downstream of the pump cell 150. In such a state, a signal outputted from each of the cells is offset, and thus accuracy of detection of nitrogen oxides is reduced. The deterioration determination section 13 determines whether such deterioration has occurred in the pump cell 150. A specific method of the determination will be described later.

The threshold setting section 14 is a section that sets, on the basis of a concentration of oxygen in the exhaust gas, a threshold used for the determination performed by the deterioration determination section 13. A process for setting the threshold will be described later, together with the method of the determination performed by the deterioration determination section 13.

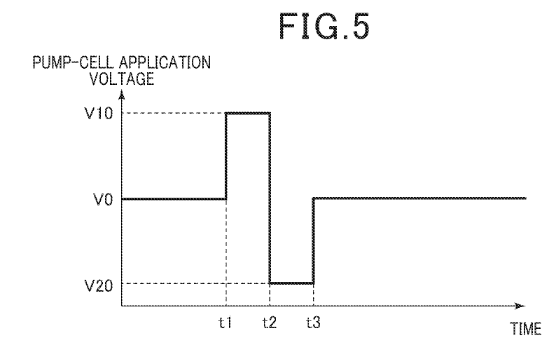

The cell temperature acquisition section 15 is a section that acquires a temperature of the pump cell 150. A method of acquiring the temperature by the cell temperature acquisition section 15 will be described with reference to FIG. 5. FIG. 5 shows an example of a change over time in an applied voltage that is applied between the pump electrode 111 and the common electrode 114. When detecting a temperature of the pump cell 150, the cell temperature acquisition section 15 temporarily increases the applied voltage. In the example in FIG. 5, during a time period from time t1 to time t2, the applied voltage is increased from V0 to V10.

When the applied voltage is increased, an electric current flowing between the pump electrode 111 and the common electrode 114 is also increased accordingly. The cell temperature acquisition section 15 calculates an impedance of the pump cell 150 by dividing an amount of increase in the applied voltage during the time period from time t1 to time t2 by an amount of increase in the electric current during the same time period.

The impedance of the pump cell 150 correlates with the temperature of the pump cell 150, and the correlation is measured in advance and is stored as a map. The cell temperature acquisition section 15 acquires the temperature of the pump cell 150 by referring to the impedance calculated as above and the map.

In the example in FIG. 5, during a time period from time t2 to time t3, the applied voltage is changed to V20, which is smaller than V0. Then, after time t3, the applied voltage is returned to the original value of V0. In the present embodiment, the applied voltage during the acquisition of the temperature is temporarily changed to V20, and this prevents electric charge from being accumulated over time in the pump cell 150.

The time period (time period from time t1 to time t3 in the example in FIG. 5) during which the applied voltage is changed for the measurement of the temperature is very short, and the time period is in the order of microseconds. The change in the electric current caused by the change in the applied voltage is very small and negligible, and thus hardly influences the measurement of the concentration of oxygen by the monitor cell 170, the measurement of the concentration of nitrogen oxides by the sensor cell 160, and the like.

The cell temperature acquisition section 15 can individually detect temperatures of the sensor cell 160 and the monitor cell 170 by a method similar to the above method.

The configuration of the control device 10 will be continuously described with reference to FIG. 2. The gas temperature acquisition section 16 is a section that acquires a temperature of the exhaust gas around the exhaust gas sensor 100. The gas temperature acquisition section 16 acquires the temperature of the exhaust gas on the basis of a signal transmitted from the gas temperature sensor 25.

The air-fuel ratio acquisition section 17 is a section that acquires an air-fuel ratio of the exhaust gas around the exhaust gas sensor 100. The air-fuel ratio acquisition section 17 acquires a concentration of oxygen in the exhaust gas on the basis of a value of the electric current flowing between the pump electrode 111 and the common electrode 114, and then acquires the air-fuel ratio on the basis of the concentration of oxygen. Alternatively, the air-fuel ratio acquisition section 17 may be configured to acquire the air-fuel ratio on the basis of a signal transmitted from a dedicated sensor provided in the exhaust pipe 20 for acquiring the air-fuel ratio. Alternatively, the air-fuel ratio acquisition section 17 may be configured to acquire the air-fuel ratio on the basis of a signal transmitted from a dedicated ECU for controlling the air-fuel ratio.

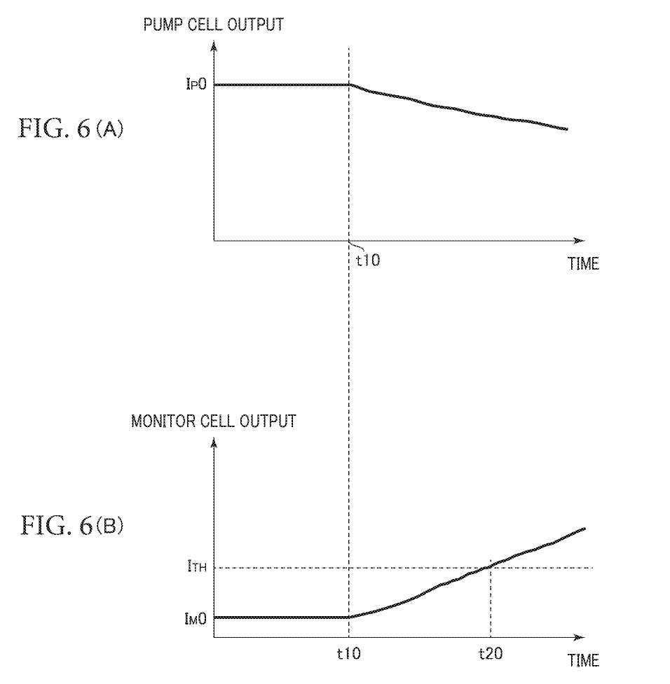

With reference to FIG. 6, description will be given of an overview of a method by which the deterioration determination section 13 determines whether the pump cell 150 has deteriorated. FIG. 6(A) shows a change over time in an electric current flowing in the pump cell 150, i.e., an electric current flowing between the pump electrode 111 and the common electrode 114. The electric current is also termed a “pump cell current” hereinafter. The pump cell current is a signal which is outputted from the pump cell 150 and whose magnitude indicates an amount of oxygen discharged by the pump cell 150.

FIG. 6(B) shows a change over time in an electric current flowing in the monitor cell 170, i.e., an electric current flowing between the monitor electrode 113 and the common electrode 114. The electric current is also termed a “monitor cell current” hereinafter. The monitor cell current is a signal which is outputted from the monitor cell 170 and whose magnitude indicates a concentration of oxygen in the exhaust gas that has reached the monitor cell 170.

In the example in FIG. 6, during a time period until time t10, the pump cell current shown in FIG. 6(A) has an approximately constant value (I_{P}0).

Furthermore, the monitor cell current shown in FIG. 6 (B) has also an approximately constant value (I_{M}0).

After time t10, the pump cell 150 has deteriorated, and a capacity of the pump cell 150 to discharge oxygen is gradually reduced. Accordingly, the pump cell current shown in FIG. 6(A) is gradually reduced after time t10.

When the capacity of the pump cell 150 to discharge oxygen is reduced, an amount of oxygen reaching the monitor cell 170 is increased accordingly. Thus, the monitor cell current shown in FIG. 6(B) is gradually increased after time t10. As a degree of deterioration of the pump cell 150 is increased, the monitor cell current is also increased.

Therefore, when a magnitude of the monitor cell current (i.e., the signal outputted from the second cell) has exceeded a predetermined threshold, the deterioration determination section 13 according to the present embodiment determines that the pump cell 150 has deteriorated. In the example in FIG. 6 (B), the threshold is indicated as I_{TH}. Thus, after time t20, at which the monitor cell current has exceeded I_{TH}, the deterioration determination section 13 determines that the pump cell 150 has deteriorated.

In a situation where a concentration of oxygen in the exhaust gas around the exhaust gas sensor 100 is high, even when the pump cell 150 has not deteriorated, the monitor cell current outputted from the monitor cell 170 is large. On the other hand, in a situation where the concentration of oxygen in the exhaust gas around the exhaust gas sensor 100 is low, even when the pump cell 150 has deteriorated, the monitor cell current outputted from the monitor cell 170 is small. Thus, if the threshold is a fixed value which is always constant, the deterioration determination section 13 may be unable to accurately perform the determination.

In the present embodiment, therefore, the threshold used for the determination is not a fixed value which is always constant, but is changed as appropriate by the threshold setting section 14. The threshold setting section 14 sets the threshold according to the concentration of oxygen in the exhaust gas. Specifically, as the concentration of oxygen in the exhaust gas is higher, the threshold is set to a larger value. Since the threshold is set as appropriate according to the concentration of oxygen, the deterioration determination section 13 can always accurately perform the determination. Opportunities to perform the deterioration determination for the pump cell 150 are not limited only to the case where the concentration of oxygen in the exhaust gas has a specific value. This enables the deterioration determination to be performed at a higher frequency than in a conventional device.

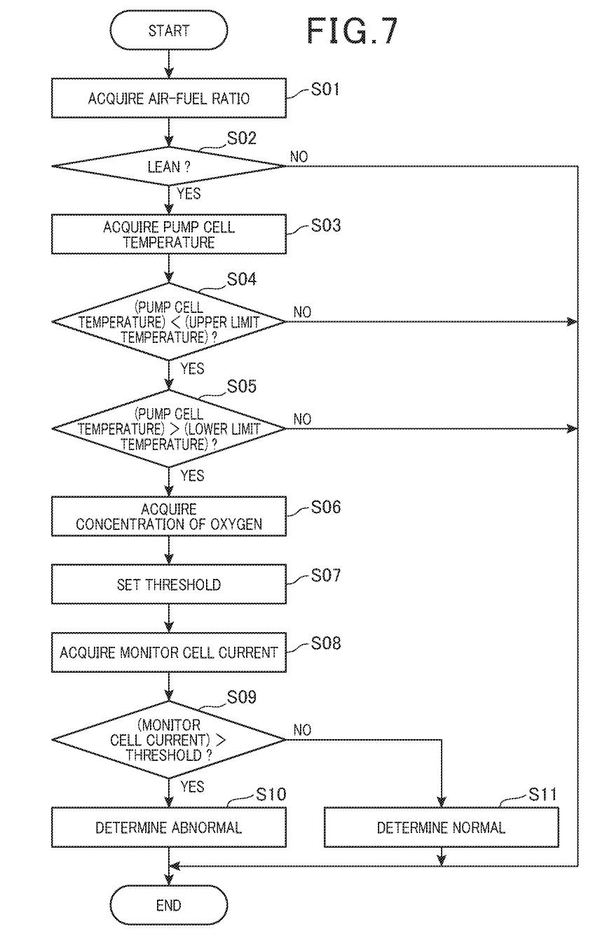

A specific process for performing the above determination will be described with reference to FIG. 7. A series of processes shown in FIG. 7 is repeatedly performed by the control device 10 for each predetermined control cycle.

At step S01, which is a first step of the process, the air-fuel ratio acquisition section 17 acquires an air-fuel ratio of the exhaust gas around the exhaust gas sensor 100.

At step S02 subsequent to step S01, it is determined whether the air-fuel ratio acquired at step S01 is lean, i.e., whether the air-fuel ratio is more than what is called a theoretical air-fuel ratio. When the air-fuel ratio is not lean, the series of processes shown in FIG. 7 ends, without determining whether the pump cell 150 has deteriorated. When the air-fuel ratio is lean, control proceeds to step S03.

At step S03, the cell temperature acquisition section 15 acquires a temperature of the pump cell 150. The temperature is acquired by the method as already described with reference to FIG. 5.

In the present embodiment, a predetermined temperature range is set in advance as a temperature range that allows the pump cell 150 to be properly operated. At step S04 subsequent to step S03, it is determined whether the temperature of the pump cell 150 acquired at step S03 is lower than an upper limit temperature of the temperature range. When the temperature of the pump cell 150 is the upper limit temperature or higher, the capacity of the pump cell 150 to discharge oxygen is higher than normal, and the monitor cell current is reduced. This prevents determination at step S09 (described later) from being accurately performed. In this case, therefore, the series of processes shown in FIG. 7 ends, without determining whether the pump cell 150 has deteriorated. When the temperature of the pump cell 150 is lower than the upper limit temperature, control proceeds to step S05.

At step S05, it is determined whether the temperature of the pump cell 150 acquired at step S03 is higher than a lower limit temperature of the temperature range. When the temperature of the pump cell 150 is the lower limit temperature or lower, the pump cell 150 and the monitor cell 170 are inactive altogether, and this also prevents the determination at step S09 (described later) from being accurately performed. Also in this case, therefore, the series of processes shown in FIG. 7 ends, without determining whether the pump cell 150 has deteriorated. When the temperature of the pump cell 150 is higher than the lower limit temperature, i.e., when the temperature of the pump cell 150 falls within the temperature range, control proceeds to step S06.

At step S06, a concentration of oxygen in the exhaust gas is acquired. In the present embodiment, the concentration of oxygen is acquired on the basis of a magnitude of the pump cell current. Alternatively, the concentration of oxygen in the exhaust gas may be acquired on the basis of a signal from a dedicated sensor for acquiring the concentration of oxygen.

At step S07 subsequent to step S06, the threshold setting section 14 sets a threshold. The threshold is the threshold indicated as I_{TH} in FIG. 6 (B). At this step, the threshold is set on the basis of the concentration of oxygen acquired at step S06. Specifically, the threshold setting section 14 of the present embodiment sets the threshold on the basis of the signal (pump cell current) outputted from the pump cell 150.

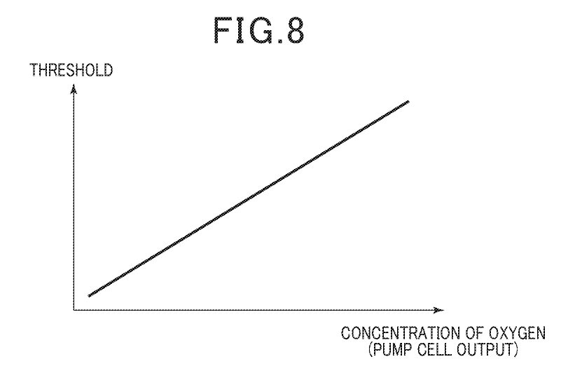

FIG. 8 shows an example of a relationship between the concentration of oxygen (lateral axis) acquired at step S06 and the threshold (longitudinal axis) to be set. A graph showing the relationship between the concentration of oxygen and the threshold may be a straight line increasing from left to right as in the example in FIG. 8, or may be a curve increasing from left to right. In either of the cases, as the concentration of oxygen acquired at step S06 is higher, the threshold is set to a larger value. The threshold set by the threshold setting section 14 may be calculated by multiplying, by a ratio corresponding to the concentration of oxygen, an initial threshold (a threshold individually calibrated considering differences among devices) set in advance during a production step, or may be calculated by adding, to the initial threshold, an offset value corresponding to the concentration of oxygen.

When the pump cell 150 has deteriorated, an error may seem to occur in the concentration of oxygen acquired at step S06, i.e., the concentration of oxygen calculated on the basis of the magnitude of the pump cell current. In the present embodiment, however, the deterioration determination section 13 determines that the pump cell 150 has deteriorated, when the monitor cell current has changed in the order of nA. At this point, the pump cell current which is an electric current in the order of mA hardly changes. That is, the deterioration of the pump cell 150 determined in the present embodiment hardly causes the pump cell current to change, and thus has little influence that causes an error in the concentration of oxygen acquired at step S06.

At step S08 subsequent to step S07, a value of the monitor cell current is acquired. At step S09 subsequent to step S08, it is determined whether the monitor cell current acquired at step S08 has exceeded the threshold set at step S07.

When the monitor cell current has exceeded the threshold, control proceeds to step S10. When control proceeds to step S10, it is assumed that the capacity of the pump cell 150 to discharge oxygen has been reduced and consequently the monitor cell current is larger than normal. Thus, at step S10, the deterioration determination section 13 determines that an abnormality has occurred in the measurement by the exhaust gas sensor 100, specifically, determines that the pump cell 150 has deteriorated.

At step S09, when the monitor cell current is the threshold or less, control proceeds to step S11. When control proceeds to step S11, it is assumed that the capacity of the pump cell 150 to discharge oxygen is properly exerted and consequently the monitor cell current is sufficiently small. Thus, at step S11, the deterioration determination section 13 determines that the measurement by the exhaust gas sensor 100 has properly been performed, specifically, determines that the pump cell 150 has not deteriorated. Through the processes described above, the determination is performed by the method described with reference to FIG. 6.

When the deterioration determination section 13 determines that the pump cell 150 has deteriorated, the control device 10 determines that a failure has occurred in the sensor, and provides notification to a driver such as illumination of a warning light. Furthermore, other measures can be taken such as masking various signals acquired from the exhaust gas sensor 100 so that the signals are not used to control the internal combustion engine EG or stopping energization to the pump cell 150, the sensor cell 160, the monitor cell 170, and the heater 180 so that the exhaust gas sensor 100 is not driven. By stopping energization to the exhaust gas sensor 100, it is possible to prevent or reduce energy loss occurring in the exhaust gas sensor 100 when it is determined that a failure has occurred.

In the present embodiment, when the temperature of the pump cell 150 is lower than the predetermined lower limit temperature (when a negative determination is made (No) at step 505), or when the temperature of the pump cell 150 is higher than the predetermined upper limit temperature (when a negative determination is made (No) at step S04), the deterioration determination section 13 does not determine whether the pump cell 150 has deteriorated. This reduces the influence of the change, according to the temperature of the pump cell 150, in the capacity of the pump cell 150 to discharge oxygen. Thus, the deterioration determination section 13 can accurately perform the determination.

When the air-fuel ratio of the exhaust gas is richer than the theoretical air-fuel ratio, the concentration of oxygen in the exhaust gas is low. Accordingly, even when the pump cell 150 has deteriorated and the capacity of the pump cell 150 to discharge oxygen has been reduced, the concentration of oxygen in the vicinity of the monitor cell 170 is low. Thus, the monitor cell current may become less than the threshold, and this may cause erroneous determination that the pump cell 150 has not deteriorated.

In the present embodiment, therefore, only when the air-fuel ratio of the exhaust gas is leaner than the theoretical air-fuel ratio (when an affirmative determination is made (Yes) at step S02), the deterioration determination section 13 determines whether the pump cell 150 has deteriorated. This prevents occurrence of erroneous determination as mentioned above. In a case where erroneous determination as mentioned above can be prevented by properly setting the threshold, the deterioration determination section 13 may always perform the determination without the determination at step S02.

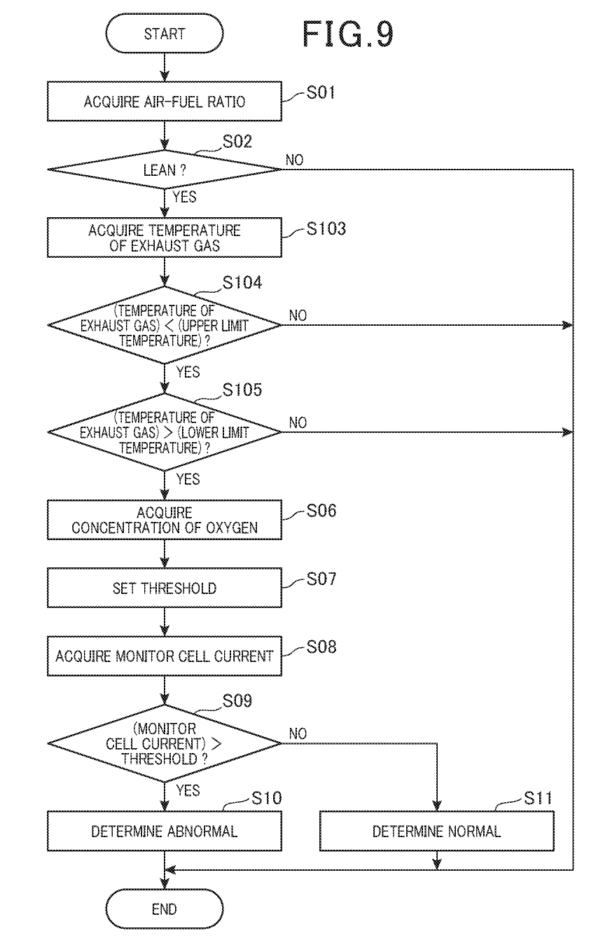

A modified example of the first embodiment will be described. The modified example differs from the first embodiment in part of the processes performed by the control device 10. A series of processes shown in FIG. 9 is performed by the control device 10 according to the modified example, in place of the series of processes shown in FIG. 7.

The series of processes shown in FIG. 9 is obtained by replacing the processes at steps S03, S04, and S05 in FIG. 7 with processes at step S103, S104, and S105, respectively. Only differences from the processes shown in FIG. 7 will be described below.

In the present embodiment, a predetermined temperature range is set in advance as a temperature range of the exhaust gas that allows the exhaust gas sensor 100 to properly perform the measurement of the concentration. At step S103, the gas temperature acquisition section 16 acquires a temperature of the exhaust gas. At step S104 subsequent to step S103, it is determined whether the temperature of the exhaust gas acquired at step S103 is lower than an upper limit temperature of the temperature range. When the temperature of the exhaust gas is the upper limit temperature or higher, the pump cell 150 is heated by the exhaust gas, and thus the capacity of the pump cell 150 to discharge oxygen becomes higher than normal. As a result, the monitor cell current is reduced, and this prevents determination at step S09 from being accurately performed. In this case, therefore, the series of processes shown in FIG. 9 ends, without determining whether the pump cell 150 has deteriorated. When the temperature of the exhaust gas is lower than the upper limit temperature, control proceeds to step S105.

At step S105, it is determined whether the temperature of the exhaust gas acquired at step S103 is higher than a lower limit temperature of the temperature range. When the temperature of the exhaust gas is the lower limit temperature or lower, temperatures of the pump cell 150 and the monitor cell 170 may become excessively low, and this may prevent the determination at step S09 from being accurately performed. Also in this case, therefore, the series of processes shown in FIG. 9 ends, without determining whether the pump cell 150 has deteriorated. In a case where the heater 180 can prevent the temperatures of the pump cell 150 and the monitor cell 170 from being excessively low, the determination at step S105 does not need to be performed.

When the temperature of the exhaust gas is higher than the lower limit temperature, i.e., when the temperature of the exhaust gas falls within the temperature range, control proceeds to step S06. Subsequent processes are the same as those described with reference to FIG. 7.

In the modified example, when the temperature of the exhaust gas is lower than the predetermined lower limit temperature (when a negative determination is made (No) at step S105), or when the temperature of the exhaust gas is higher than the predetermined upper limit temperature (when a negative determination is made (No) at step S104), the deterioration determination section 13 does not determine whether the pump cell 150 has deteriorated. This reduces the influence of the change, according to the temperature of the exhaust gas, in the capacity of the pump cell 150 to discharge oxygen. Thus, the deterioration determination section 13 can accurately perform the determination.

The processes from step S103 to step S105 may be performed in place of the processes from step S03 to step S05 in FIG. 7, or may be performed together with the processes from step S03 to step S05 in FIG. 7.

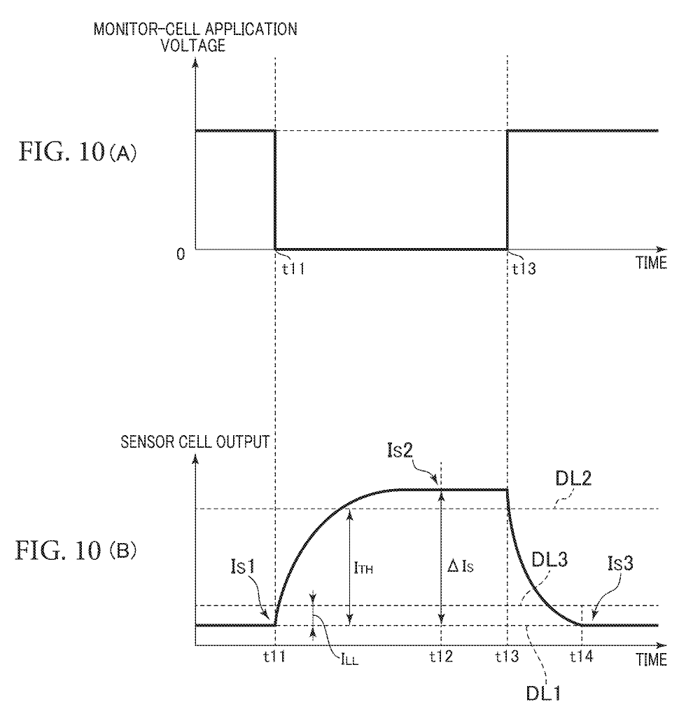

A second embodiment will be described. The present embodiment differs from the first embodiment in the method of the deterioration performed by the determination section 13. An overview of the determination method of the present embodiment will be described with reference to FIG. 10.

FIG. 10(A) shows a change over time in an applied voltage that is applied to the monitor cell 170, i.e., an applied voltage that is applied between the monitor electrode 113 and the common electrode 114. FIG. 10(B) shows a change over time in an electric current flowing in the sensor cell 160, i.e., an electric current flowing between the sensor electrode 112 and the common electrode 114 during the same time period as that in FIG. 10(A). The electric current is also termed a “sensor cell current” hereinafter. The sensor cell current is a signal which is outputted from the sensor cell 160 and whose magnitude indicates a concentration of oxygen and nitrogen oxides in the exhaust gas that has reached the sensor cell 160.

In the example shown in FIG. 10, the applied voltage that is applied to the monitor cell 170 has a constant value. However, during a time period from time t11 to time t13, the application of the voltage to the monitor cell 170 is temporarily stopped.

When the application of the voltage to the monitor cell 170 is stopped, the monitor cell 170 stops discharging oxygen, and thus an amount of oxygen reaching the sensor cell 160 is increased. Accordingly, as shown in FIG. 10(B), after time t11, at which the application of the voltage is stopped, a value of the sensor cell current is gradually increased from an original value I_{S}1, and becomes approximately constant when the value reaches I_{S}2. In FIG. 10(B), after time t11, a time at which the sensor cell current is increased to reach the approximately constant value is indicated as time t12.

At time t13, when the application of the voltage to the monitor cell 170 is resumed, the monitor cell 170 resumes discharging oxygen, and thus the amount of oxygen reaching the sensor cell 160 is reduced. Accordingly, as shown in FIG. 10(B), after time t13, at which the application of the voltage is resumed, a value of the sensor cell current is gradually reduced from I_{S}2, and becomes approximately constant when the value reaches I_{S}3. The value I_{S}3 may match the value I_{S}1 or may differ from the value I_{S}1. In FIG. 10(B), a time at which the sensor cell current is reduced to reach I_{S}3 is indicated as time t14.

A dotted line DL1 shown in FIG. 10(B) is a straight line indicating a change over time in the sensor cell current when assuming that the sensor cell current changes with a constant inclination from I_{S}1 to I_{S}3 during a time period from time t11 to time t14. Thus, the dotted line DL1 is a straight line indicating a change over time in the sensor cell current when the application of the voltage is not stopped after time t11.

In FIG. 10(B), a difference between I_{S}2 and the dotted line DL1 at time t12 is indicated as ΔI_{S}. The value ΔI_{S} indicates an amount of increase in the sensor cell current caused by the temporal stop of the application of the voltage to the monitor cell 170.

When the pump cell 150 has deteriorated and the capacity of the pump cell 150 to discharge oxygen has been reduced, a relatively large amount of oxygen has reached the vicinity of the sensor cell 160 and the monitor cell 170. In such a situation, the amount of increase in the sensor cell current when the application of the voltage to the monitor cell 170 is stopped is large.

Therefore, the deterioration determination section 13 according to the present embodiment temporarily stops the application of the voltage to the monitor cell 170. Then, when the amount of increase in the sensor cell current (i.e., the amount of increase in the magnitude of the signal outputted from the sensor cell 160) has exceeded a threshold while the application of the voltage to the monitor cell 170 is temporarily stopped, the deterioration determination section 13 determines that the pump cell 150 has deteriorated. In FIG. 10(B), the threshold is indicated as I_{TH}. Furthermore, a dotted line DL2 shown in FIG. 10(B) is obtained by shifting the dotted line DL1 upward by I_{TH}. In the example in FIG. 10(B), the magnitude of the sensor cell current has exceeded the dotted line DL2. That is, the amount of increase in the sensor cell current has exceeded I_{TH}. Accordingly, the deterioration determination section 13 determines that the pump cell 150 has deteriorated.

In a case where the monitor cell 170 has deteriorated and the capacity of the monitor cell 170 to discharge oxygen has been reduced, even when the application of the voltage to the monitor cell 170 is temporarily stopped, an amount of oxygen discharged by the monitor cell 170 (since it is almost zero from the beginning) hardly changes. Accordingly, the amount of increase in the sensor cell current in this case is very small.

Therefore, the deterioration determination section 13 according to the present embodiment temporarily stops the application of the voltage to the monitor cell 170. Then, when the amount of increase in the sensor cell current (i.e., the amount of increase in the magnitude of the signal outputted from the sensor cell 160) is less than a lower limit value while the application of the voltage to the monitor cell 170 is temporarily stopped, the deterioration determination section 13 determines that the monitor cell 170 has deteriorated.

The lower limit value is set to a value smaller than the threshold. In FIG. 10(B), the lower limit value is indicated as I_{LL}. Furthermore, a dotted line DL3 shown in FIG. 10(B) is obtained by shifting the dotted line DL1 upward by I_{LL}. In the example in FIG. 10(B), the magnitude of the sensor cell current has exceeded the dotted line DL3. That is, the amount of increase in the sensor cell current has exceeded I_{LL}. Accordingly, the deterioration determination section 13 determines that the monitor cell 170 has not deteriorated.

Thus, in addition to determining whether the pump cell 150 has deteriorated, the deterioration determination section 13 according to the present embodiment is capable of also determining whether the monitor cell 170 has deteriorated.

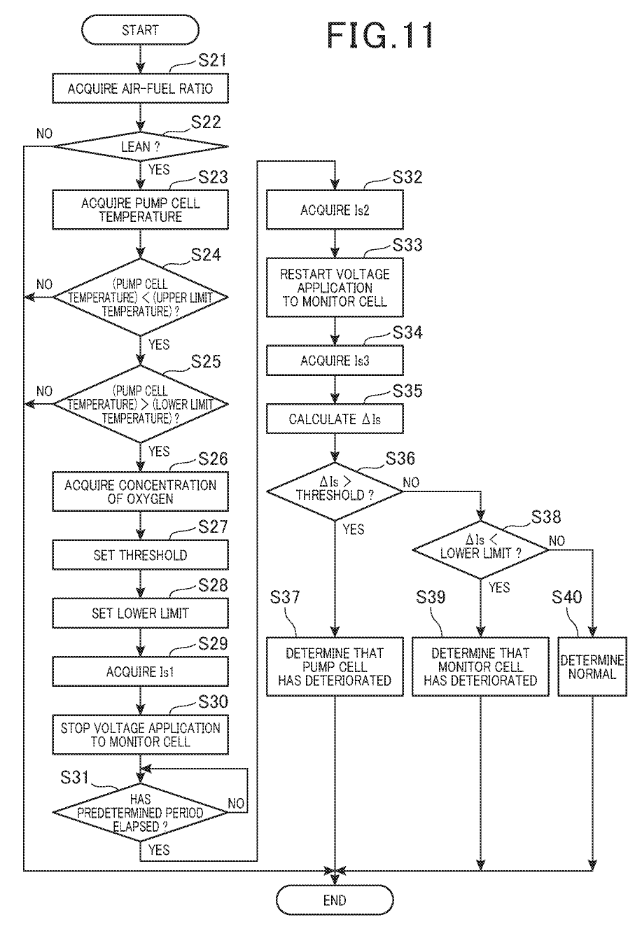

A specific process for performing the above determination will be described with reference to FIG. 11. A series of processes shown in FIG. 11 is repeatedly performed by the control device 10 for each predetermined control cycle, in place of the series of processes shown in FIG. 7.

Processes from step S21 to step S27 in FIG. 11 are the same as the processes from step S01 to step S07 in FIG. 7, respectively. Thus, specific description of those will be omitted. However, a threshold set at step S27 in FIG. 11 is not a threshold to be compared with the monitor cell current, but is a threshold to be compared with the amount of increase in the sensor cell current.

At step S28 subsequent to step S27, a lower limit value is set. The lower limit value is the lower limit value indicated as I_{LL} in FIG. 10(B). In the present embodiment, the lower limit value is set each time on the basis of the concentration of oxygen acquired at step S26 and the like. Specifically, as the concentration of oxygen is higher, the lower limit value is set to a larger value. Alternatively, the lower limit value may always be set to the same value.

At step S29 subsequent to step S28, a value of the sensor cell current is acquired. The value of the sensor cell current acquired at this step is a value of the sensor cell current before the application of the voltage to the monitor cell 170 is temporarily stopped, and corresponds to I_{S}1 in FIG. 10(B).

At step S30 subsequent to step S29, the application of the voltage to the monitor cell 170 is stopped. At step S31 subsequent to step S30, it is determined whether a predetermined time period has elapsed from when the process at step S30 has been performed. When the predetermined time period has not elapsed, the process at step S31 is repeatedly performed. When the predetermined time period has elapsed, control proceeds to step S32.

At step S32, a value of the sensor cell current is acquired. The value of the sensor cell current acquired at this step is a value of the sensor cell current after the application of the voltage to the monitor cell 170 is temporarily stopped, and corresponds to I_{S}2 in FIG. 10(B).

At step S33 subsequent to step S32, the application of the voltage to the monitor cell 170 is resumed.

At step S34 subsequent to step S33, a value of the sensor cell current is acquired. The value of the sensor cell current acquired at this step is a value of the sensor cell current after the application of the voltage to the monitor cell 170 is resumed, and corresponds to I_{S}3 in FIG. 10(B).

At step S35 subsequent to step S34, an amount of increase in the sensor cell current is calculated on the basis of the electric current values (i.e., I_{S}1, I_{S}2, and I_{S}3) acquired at steps S29, S32, and S34, respectively. The amount of increase corresponds to ΔI_{S} in FIG. 10 (B). The amount of increase (ΔI_{S}) can be calculated, for example, by equation: ΔI_{S}=I_{S}2−(I_{S}1+((I_{S}3−I_{S}1)/(t14−t11))×(t12−t11)).

At step S36 subsequent to step S35, it is determined whether the amount of increase in the sensor cell current calculated at step S35 has exceeded the threshold set at step S27.

When the amount of increase in the sensor cell current has exceeded the threshold, control proceeds to step S37. When control proceeds to step S37, it is assumed that the capacity of the pump cell 150 to discharge oxygen has been reduced and consequently the amount of increase in the sensor cell current is larger than normal. Thus, at step S37, the deterioration determination section 13 determines that an abnormality has occurred in the measurement by the exhaust gas sensor 100, specifically, determines that the pump cell 150 has deteriorated.

At step S36, when the amount of increase in the sensor cell current is the threshold or less, control proceeds to step S38. At step S38, it is determined whether the amount of increase in the sensor cell current calculated at step S35 is less than the lower limit value set at step S28. When the amount of increase in the sensor cell current is less than the lower limit value, control proceeds to step S39.

When control proceeds to step S39, it is assumed that the capacity of the monitor cell 170 to discharge oxygen has been reduced and consequently the amount of increase in the sensor cell current is small. Thus, at step S39, the deterioration determination section 13 determines that an abnormality has occurred in the measurement by the exhaust gas sensor 100, specifically, determines that the monitor cell 170 has deteriorated.

At step S38, when the amount of increase in the sensor cell current is the lower limit value or more, control proceeds to step S40. When control proceeds to step S40, it is assumed that the capacity of the pump cell 150 to discharge oxygen is properly exerted and consequently the amount of increase in the sensor cell current is small. Furthermore, it is assumed that the capacity of the monitor cell 170 to discharge oxygen is also properly exerted and consequently the amount of increase in the sensor cell current is not excessively small. Thus, at step S40, the deterioration determination section 13 determines that the measurement by the exhaust gas sensor 100 has properly been performed, specifically, determines that neither the pump cell 150 nor the monitor cell 170 has deteriorated. Through the processes described above, the determination is performed by the method described with reference to FIG. 10.

The value I_{S}2 used to calculate the amount of increase in the sensor cell current may be a value obtained after the sensor cell current is increased to reach a constant value, or may be a value obtained while the sensor cell current is increasing. For example, the predetermined time period at step S31 may be shorter than time required until the sensor cell current becomes constant. The value ΔI_{S} calculated in this case indicates an inclination with which the sensor cell current is increased. The deterioration determination section 13 may compare the ΔI_{S} calculated as above with the threshold to determine whether the pump cell 150 has deteriorated.

The monitor cell 170 has the same function (function of decomposing oxygen) as the pump cell 150. Accordingly, when the pump cell 150 has deteriorated, the monitor cell 170 may also have deteriorated due to the same cause. Thus, as in the first embodiment, when the deterioration determination for the pump cell 150 is performed on the basis of the signal (monitor cell current) outputted from the monitor cell 170, there is a slight possibility that simultaneous deterioration of the pump cell 150 and the monitor cell 170 may cause erroneous determination in the deterioration determination.

In the present embodiment, therefore, the deterioration determination section 13 performs the deterioration determination for the pump cell 150 on the basis of not the monitor cell current but of the sensor cell current. Since the deterioration determination is performed on the basis of the signal (sensor cell current) outputted from the sensor cell 160 having a function (function of decomposing oxygen and nitrogen oxides) different from that of the pump cell 150, erroneous determination as mentioned above is prevented.

Immediately after the application of the voltage to the monitor cell 170 is stopped, the sensor cell current may temporarily become unstable, and this may cause variations in the magnitude of the sensor cell current. Thus, if the deterioration determination on the basis of the sensor cell current is performed while the sensor cell current is unstable, variations in the sensor cell current may cause erroneous determination.

Therefore, after the predetermined time period has elapsed from the temporary stop of the application of the voltage to the monitor cell 170 (after an affirmative determination is made (Yes) at step S31), the deterioration determination section 13 of the present embodiment acquires the amount of increase in the sensor cell current, and on the basis of the amount of increase, determines whether the pump cell 150 has deteriorated. This prevents erroneous determination as mentioned above.

While the application of the voltage to the monitor cell 170 is temporarily stopped, a concentration of nitrogen oxides cannot be measured by the exhaust gas sensor 100. Thus, while the deterioration determination as described above is being performed, the control by the internal combustion engine control section 12, i.e., the control of the internal combustion engine EG on the basis of the concentration of nitrogen oxides is temporarily interrupted.

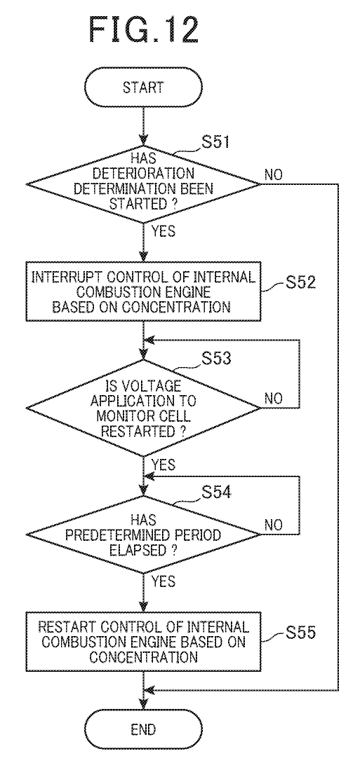

A specific process for the temporary interruption of the control of the internal combustion engine EG on the basis of the concentration of nitrogen oxides will be described with reference to FIG. 12. A series of processes shown in FIG. 12 is repeatedly performed by the control device 10 for each predetermined control cycle. This series of processes is simultaneously performed with the series of processes shown in FIG. 11.

At step S51, which is a first step of the process, it is determined whether the deterioration determination has been started. At this step, in a case where the application of the voltage has been stopped at step S30 in FIG. 11, it is determined that the deterioration determination has been started. When the deterioration determination has not yet been started, the series of processes shown in FIG. 12 ends. In this case, the internal combustion engine EG is controlled as usual.

At step S51, when the deterioration determination has been started, control proceeds to step S52. At step S52, the control of the internal combustion engine EG on the basis of the concentration of nitrogen oxides is interrupted. At subsequent steps, the internal combustion engine EG is controlled not on the basis of the concentration of nitrogen oxides.

At step S53 subsequent to step S52, it is determined whether the application of the voltage to the monitor cell 170 has been resumed. That is, it is determined whether the process at step S33 in FIG. 11 has been performed. When the application of the voltage has not yet been resumed, the process at step S53 is repeatedly performed. When the application of the voltage has been resumed, control proceeds to step S54.

At step S54, it is determined whether a predetermined time period has elapsed from when the application of the voltage to the monitor cell 170 has been resumed. When the predetermined time period has not elapsed, the process at step S54 is repeatedly performed. When the predetermined time period has elapsed, control proceeds to step S55. At step S55, the control of the internal combustion engine EG on the basis of the concentration of nitrogen oxides is resumed.

Immediately after the application of the voltage to the monitor cell 170 is resumed, the monitor cell current and the sensor cell current may temporarily become unstable, and this may cause variations in the respective magnitudes of the monitor cell current and the sensor cell current. Thus, while the monitor cell current and the sensor cell current are unstable, the concentration detection section 11 cannot accurately detect a concentration of nitrogen oxides. It is not preferable to control the internal combustion engine EG on the basis of the inaccurate concentration obtained during this time period.

Therefore, the internal combustion engine control section 12 of the present embodiment does not control the internal combustion engine on the basis of the concentration of nitrogen oxides until the predetermined time period has elapsed after the application of the voltage to the monitor cell 170 is resumed (until an affirmative determination is made (Yes) at step S54). This prevents a situation where the internal combustion engine EG is controlled on the basis of an inaccurate concentration.

A third embodiment will be described. In the second embodiment described above, the application of the voltage to the monitor cell 170 is temporarily stopped, and the deterioration determination is performed on the basis of the amount of increase in the sensor cell current while the application of the voltage to the monitor cell 170 is temporarily stopped. On the other hand, in the present embodiment, the application of the voltage to the sensor cell 160 is temporarily stopped, and the deterioration determination is performed on the basis of an amount of increase in the monitor cell current while the application of the voltage to the sensor cell 160 is temporarily stopped.

In this case, a change over time in an applied voltage that is applied to the sensor cell 160, i.e., an applied voltage that is applied between the sensor electrode 112 and the common electrode 114 forms a waveform similar to that shown in FIG. 10(A). Furthermore, a change over time in the monitor cell current forms a waveform similar to that shown in FIG. 10(B). Hereinafter, a value of the monitor cell current corresponding to I_{S}1 in FIG. 10(B) is represented as I_{M}1. Similarly, values of the monitor cell current corresponding to I_{S}2 and I_{S}3 in FIG. 10(B) are represented as I_{M}2 and I_{M}3, respectively. Furthermore, a value of the amount of increase in the monitor cell current during a time period from time t11 to time t13, i.e., a value of the amount of increase in the monitor cell current corresponding to ΔI_{S} in FIG. 10(B) is represented as ΔI_{M}.

When the application of the voltage to the sensor cell 160 is stopped, the sensor cell 160 stops discharging oxygen and the like, and thus the amount of oxygen reaching the monitor cell 170 is increased. Accordingly, after time t11, at which the application of the voltage is stopped, a value of the monitor cell current is gradually increased from an original value I_{M}1, and becomes approximately constant when the value reaches I_{M}2.

When the application of the voltage to the sensor cell 160 is resumed, the sensor cell 160 resumes discharging oxygen and the like, and thus the amount of oxygen reaching the monitor cell 170 is reduced. Accordingly, after a time at which the application of the voltage is resumed, a value of the monitor cell current is gradually reduced from I_{M}2, and becomes approximately constant when the value reaches I_{M}3. The value I_{M}3 may match the value I_{M}1 or may differ from the value I_{M}1.

When the pump cell 150 has deteriorated and the capacity of the pump cell 150 to discharge oxygen has been reduced, a relatively large amount of oxygen has reached the vicinity of the sensor cell 160 and the monitor cell 170. In such a situation, the amount of increase in the monitor cell current when the application of the voltage to the sensor cell 160 is stopped is large.

Therefore, the deterioration determination section 13 according to the present embodiment temporarily stops the application of the voltage to the sensor cell 160. Then, when the amount of increase in the monitor cell current (i.e., the amount of increase in the magnitude of the signal outputted from the monitor cell 170) has exceeded a threshold while the application of the voltage to the sensor cell 160 is temporarily stopped, the deterioration determination section 13 determines that the pump cell 150 has deteriorated.

In a case where the sensor cell 160 has deteriorated and the capacity of the sensor cell 160 to discharge oxygen and the like have been reduced, even when the application of the voltage to the sensor cell 160 is temporarily stopped, an amount of oxygen discharged by the sensor cell 160 (since it is almost zero from the beginning) hardly changes. Accordingly, the amount of increase in the monitor cell current in this case is very small.

Therefore, the deterioration determination section 13 according to the present embodiment temporarily stops the application of the voltage to the sensor cell 160. Then, when the amount of increase in the monitor cell current (i.e., the amount of increase in the magnitude of the signal outputted from the monitor cell 170) is less than a lower limit value while the application of the voltage to the sensor cell 160 is temporarily stopped, the deterioration determination section 13 determines that the sensor cell 160 has deteriorated. The lower limit value is set to a value smaller than the threshold.

Thus, in addition to determining whether the pump cell 150 has deteriorated, the deterioration determination section 13 according to the present embodiment is capable of also determining whether the sensor cell 160 has deteriorated.

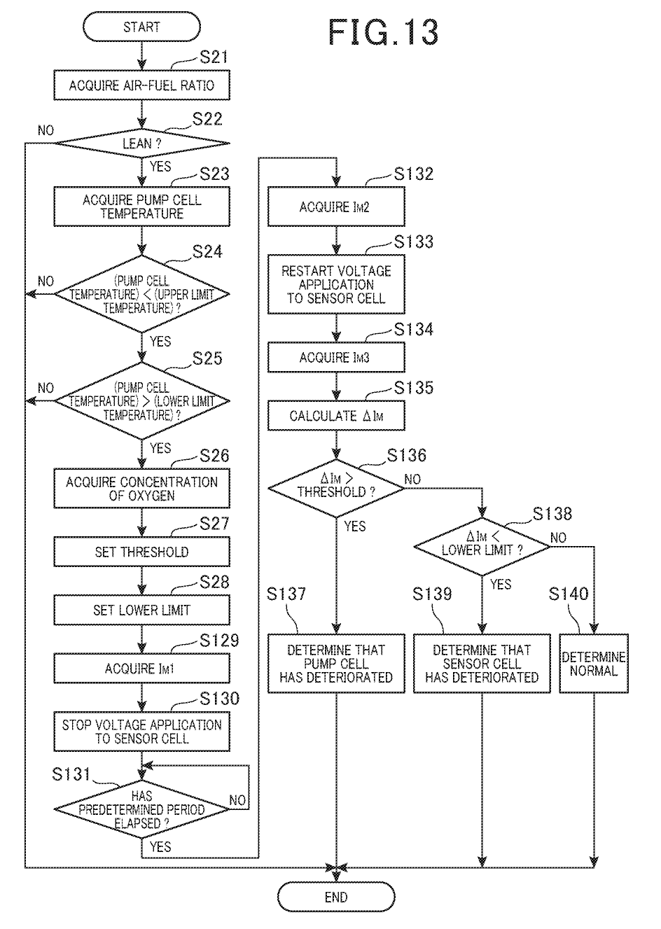

A specific process for performing the above determination will be described with reference to FIG. 13. A series of processes shown in FIG. 13 is repeatedly performed by the control device 10 for each predetermined control cycle, in place of the series of processes shown in FIG. 7.

Processes from step S21 to step S28 in FIG. 13 are the same as the processes from step S21 to step S28 in FIG. 11, respectively. Thus, specific description of those will be omitted. However, a threshold set at step S27 in FIG. 13 is not a threshold to be compared with the amount of increase (ΔI_{S}) in the sensor cell current, but is a threshold to be compared with the amount of increase (ΔI_{M}) in the monitor cell current. Furthermore, a lower limit value set at step S28 in FIG. 13 is not a lower limit value to be compared with the amount of increase (ΔI_{S}) in the sensor cell current, but is a lower limit value to be compared with the amount of increase (ΔI_{M}) in the monitor cell current.

At step S129 subsequent to step S28, a value of the monitor cell current is acquired. The value of the monitor cell current acquired at this step is a value of the monitor cell current before the application of the voltage to the sensor cell 160 is temporarily stopped, and corresponds to the value (i.e., I_{M}1) acquired immediately before time t11 in FIG. 10(B).

At step S130 subsequent to step S129, the application of the voltage to the sensor cell 160 is stopped. At step S131 subsequent to step S130, it is determined whether a predetermined time period has elapsed from when the process at step S130 has been performed. When the predetermined time period has not elapsed, the process at step S131 is repeatedly performed. When the predetermined time period has elapsed, control proceeds to step S132.

At step S132, a value of the monitor cell current is acquired. The value of the monitor cell current acquired at this step is a value of the monitor cell current after the application of the voltage to the sensor cell 160 is temporarily stopped, and corresponds to the value (i.e., I_{M}2) acquired at time t12 in FIG. 10(B).

At step S133 subsequent to step S132, the application of the voltage to the sensor cell 160 is resumed.

At step S134 subsequent to step S133, a value of the monitor cell current is acquired. The value of the monitor cell current acquired at this step is a value of the monitor cell current after the application of the voltage to the sensor cell 160 is resumed, and corresponds to the value (i.e., I_{M}3) acquired at time t14 in FIG. 10(B).

At step S135 subsequent to step S134, an amount of increase in the monitor cell current is calculated on the basis of the electric current values (i.e., I_{M}1, I_{M}2, and I_{M}3) acquired at steps S129, S132, and S134, respectively. The amount of increase (ΔI_{M}) can be calculated, for example, by equation: ΔI_{M}=I_{M}2−(I_{M}1+((I_{M}3−I_{M}1)/(t14−t11))×(t12−t11)).

At step S136 subsequent to step S135, it is determined whether the amount of increase in the monitor cell current calculated at step S135 has exceeded the threshold set at step S27.

When the amount of increase in the monitor cell current has exceeded the threshold, control proceeds to step S137. When control proceeds to step S137, it is assumed that the capacity of the pump cell 150 to discharge oxygen has been reduced and consequently the amount of increase in the monitor cell current is larger than normal. Thus, at step S137, the deterioration determination section 13 determines that an abnormality has occurred in the measurement by the exhaust gas sensor 100, specifically, determines that the pump cell 150 has deteriorated.

At step S136, when the amount of increase in the monitor cell current is the threshold or less, control proceeds to step S138. At step S138, it is determined whether the amount of increase (ΔI_{M}) in the monitor cell current calculated at step S135 is less than the lower limit value set at step S28. When the amount of increase in the monitor cell current is less than the lower limit value, control proceeds to step S139.

When control proceeds to step S139, it is assumed that the capacity of the sensor cell 160 to discharge oxygen has been reduced and consequently the amount of increase in the monitor cell current is small. Thus, at step S139, the deterioration determination section 13 determines that an abnormality has occurred in the measurement by the exhaust gas sensor 100, specifically, determines that the sensor cell 160 has deteriorated.

At step S138, when the amount of increase in the monitor cell current is the lower limit value or more, control proceeds to step S140. When control proceeds to step S140, it is assumed that the capacity of the pump cell 150 to discharge oxygen is properly exerted and consequently the amount of increase in the monitor cell current is small. Furthermore, it is assumed that the capacity of the sensor cell 160 to discharge oxygen is also properly exerted and consequently the amount of increase in the monitor cell current is not excessively small. Thus, at step S140, the deterioration determination section 13 determines that the measurement by the exhaust gas sensor 100 has properly been performed, specifically, determines that neither the pump cell 150 nor the sensor cell 160 has deteriorated.

The value I_{M}2 used to calculate the amount of increase in the monitor cell current may be a value obtained after the monitor cell current is increased to reach a constant value, or may be a value obtained while the monitor cell current is increasing. For example, the predetermined time period at step S131 may be shorter than time required until the monitor cell current becomes constant. The value ΔI_{M} calculated in this case indicates an inclination with which the monitor cell current is increased. The deterioration determination section 13 may compare the ΔI_{M} calculated as above with the threshold to determine whether the pump cell 150 has deteriorated.

Immediately after the application of the voltage to the sensor cell 160 is stopped, the monitor cell current may temporarily become unstable, and this may cause variations in the magnitude of the monitor cell current. Thus, if the deterioration determination on the basis of the monitor cell current is performed while the monitor cell current is unstable, variations in the monitor cell current may cause erroneous determination.

Therefore, after the predetermined time period has elapsed from the temporary stop of the application of the voltage to the sensor cell 160 (after an affirmative determination is made (Yes) at step S131), the deterioration determination section 13 of the present embodiment acquires the amount of increase in the monitor cell current, and on the basis of the amount of increase, determines whether the pump cell 150 has deteriorated. This prevents erroneous determination as mentioned above.

While the application of the voltage to the sensor cell 160 is temporarily stopped, a concentration of nitrogen oxides cannot be measured by the exhaust gas sensor 100. Thus, while the deterioration determination as described above is being performed, the control by the internal combustion engine control section 12, i.e., the control of the internal combustion engine EG on the basis of the concentration of nitrogen oxides is temporarily interrupted.

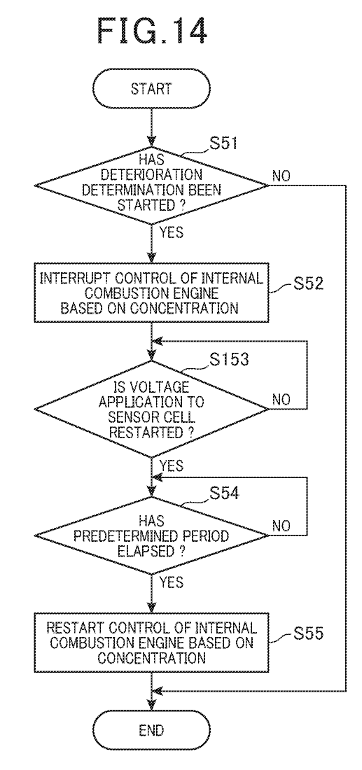

A specific process for the temporary interruption of the control of the internal combustion engine EG on the basis of the concentration of nitrogen oxides will be described with reference to FIG. 14. A series of processes shown in FIG. 14 is repeatedly performed by the control device 10 for each predetermined control cycle. This series of processes is simultaneously performed with the series of processes shown in FIG. 11.

The series of processes shown in FIG. 14 is obtained by replacing the process at step S53 in FIG. 12 with a process at step S153. Only differences from the processes shown in FIG. 12 will be described below.

At step S153 subsequent to step S52, it is determined whether the application of the voltage to the sensor cell 160 has been resumed. That is, it is determined whether the process at step S133 in FIG. 13 has been performed. When the application of the voltage has not yet been resumed, the process at step S153 is repeatedly performed. When the application of the voltage has been resumed, control proceeds to step S54. Subsequent processes are the same as those described with reference to FIG. 12.

Immediately after the application of the voltage to the sensor cell 160 is resumed, the monitor cell current and the sensor cell current may temporarily become unstable, and this may cause variations in the respective magnitudes of the monitor cell current and the sensor cell current. Thus, while the monitor cell current and the sensor cell current are unstable, the concentration detection section 11 cannot accurately detect a concentration of nitrogen oxides. It is not preferable to control the internal combustion engine EG on the basis of the inaccurate concentration obtained during this time period.

Therefore, the internal combustion engine control section 12 of the present embodiment does not control the internal combustion engine on the basis of the concentration of nitrogen oxides until the predetermined time period has elapsed after the application of the voltage to the sensor cell 160 is resumed (until an affirmative determination is made (Yes) at step S54). This prevents a situation where the internal combustion engine EG is controlled on the basis of an inaccurate concentration.

In the examples described above, the sensor cell 160 is configured to output an electric current having a magnitude corresponding to a concentration of residual oxygen and nitrogen oxides contained in the exhaust gas, while a voltage is being applied to the sensor cell 160. Alternatively, the sensor cell 160 may be configured to output a voltage having a magnitude corresponding to a concentration of residual oxygen and nitrogen oxides contained in the exhaust gas. That is, the signal outputted from the sensor cell 160 may be an electric current or a voltage.

Similarly, the monitor cell 170 may be configured to output a voltage having a magnitude corresponding to a concentration of residual oxygen contained in the exhaust gas. That is, the signal outputted from the monitor cell 170 may be an electric current or a voltage.

The embodiments have been described with reference to the specific examples. However, the present disclosure is not limited to the specific examples. Design changes to the specific examples made as appropriate by a person having ordinary skill in the art are also included in the scope of the present disclosure as long as they have the features of the present disclosure. The elements and their arrangements, conditions, shapes, and the like of the specific examples described above are not limited to those shown as examples, but may be changed as appropriate. The elements of the specific examples described above may be differently combined as appropriate as long as no technical contradiction arises.

What is claimed is:

1. A control device for an exhaust gas sensor that includes a first cell that discharges oxygen from an exhaust gas from an internal combustion engine, and a second cell that outputs a signal having a magnitude depending on a concentration of residual oxygen contained in the exhaust gas from which the oxygen has been discharged, the control device comprising:
a deterioration determination section configured to determine whether the magnitude of the signal outputted from the second cell has exceeded a threshold to thereby determine whether the first cell has deteriorated; and
a threshold setting section configured to variably set the threshold depending on a concentration of the oxygen in the exhaust gas.

2. The control device according to claim 1, wherein:
the threshold setting section is configured to increase the threshold as the concentration of the oxygen in the exhaust gas becomes higher.

3. The control device according to claim 1, wherein:
the first cell is configured to output a first-cell signal having a magnitude depending on the concentration of the oxygen in the exhaust gas; and
the threshold setter is configured to variably set the threshold based on the first-cell signal outputted from the first cell.

4. The control device according to claim 1, wherein:
the second cell comprises:
a monitor cell configured to, when a voltage applied thereto, output, as the signal, a monitor signal having the magnitude depending on the concentration of the residual oxygen contained in the exhaust gas from which the oxygen has been discharged; and
a sensor cell configured to output a sensor-cell signal having a magnitude that represents a concentration of the residual oxygen and nitrogen oxides in the exhaust gas from which the oxygen has been discharged; and
the deterioration determination section is configured to:
temporarily stop application of the voltage to the monitor cell;
determine whether an amount of an increase of the magnitude of the sensor-cell signal has exceeded the threshold during the application of the voltage being stopped; and
determine that the first cell has deteriorated upon determining that the amount of the increase of the magnitude of the sensor-cell signal has exceeded the threshold during the application of the voltage being stopped.

5. The control device according to claim 4, wherein:
the deterioration determination section is configured to:
determine whether the amount of the increase of the magnitude of the sensor-cell signal is less than a lower limit value during the application of the voltage being stopped, the lower limit value being set to be smaller than the threshold; and
determine that the monitor cell has deteriorated upon determining that the amount of the increase of the magnitude of the sensor-cell signal is less than the lower limit value during the application of the voltage being stopped.

6. The control device according to claim 4, wherein:
the deterioration determination section is configured to:
obtain a second amount of the increase of the magnitude of the sensor-cell signal when a predetermined period has elapsed since the temporal stop of the application of the voltage; and
determine whether the first cell has deteriorated based on the obtained second amount of the increase of the magnitude of the sensor-cell signal.

7. The control device according to claim 4, further comprising:
a concentration detection section configured to detect the concentration of the nitrogen oxides in the exhaust gas in accordance with the monitor signal and the sensor-cell signal outputted from the respective monitor cell and sensor cell; and
an internal combustion engine control section configured to execute control of the internal combustion engine in accordance with the concentration of the nitrogen oxides detected by the concentration detection section,
wherein the internal combustion engine control section is configured to disable execution of the control of the internal combustion engine until a predetermined period has elapsed since restart of the application of the voltage to the monitor cell.

8. The control device according to claim 1, wherein:
the second cell comprises:
a monitor cell configured to output, as the signal, a monitor signal having the magnitude depending on the concentration of the residual oxygen contained in the exhaust gas from which the oxygen has been discharged; and
a sensor cell configured to output, when a voltage applied thereto, a sensor-cell signal having a magnitude that represents a concentration of the residual oxygen and nitrogen oxides in the exhaust gas from which the oxygen has been discharged; and
the deterioration determination section is configured to:
temporarily stop application of the voltage to the sensor cell;
determine whether an amount of an increase of the magnitude of the monitor signal has exceeded the threshold during the application of the voltage being stopped; and
determine that the first cell has deteriorated upon determining that the amount of the increase of the magnitude of the monitor signal has exceeded the threshold during the application of the voltage being stopped.

9. The control device according to claim 8, wherein:
the deterioration determination section is configured to:
determine whether the amount of the increase of the magnitude of the monitor signal is less than a lower limit value during the application of the voltage being stopped, the lower limit value being set to be smaller than the threshold; and
determine that the sensor cell has deteriorated upon determining that the amount of the increase of the magnitude of the monitor signal is less than the lower limit value during the application of the voltage being stopped.

10. The control device according to claim 8, wherein:
the deterioration determination section is configured to:
obtain a second amount of the increase of the magnitude of the monitor signal when a predetermined period has elapsed since the temporal stop of the application of the voltage; and
determine whether the first cell has deteriorated based on the obtained second amount of the increase of the magnitude of the monitor signal.

11. The control device according to claim 8, further comprising:
a concentration detection section configured to detect the concentration of the nitrogen oxides in the exhaust gas in accordance with the monitor signal and the sensor-cell signal outputted from the respective monitor cell and sensor cell; and
an internal combustion engine control section configured to execute control of the internal combustion engine in accordance with the concentration of the nitrogen oxides detected by the concentration detection section,
wherein the internal combustion engine control section is configured to disable execution of the control of the internal combustion engine until a predetermined period has elapsed since restart of the application of the voltage to the sensor cell.

12. The control device according to claim 1, further comprising:
a cell temperature acquisition section configured to acquire a temperature of the first cell,
wherein the deterioration determination section is configured to disable determination of whether the first cell has deteriorated upon the temperature of the first cell being less than a predetermined lower limit temperature or more than a predetermined upper limit temperature.

13. The control device according to claim 1, further comprising:
a gas temperature acquisition section configured to acquire a temperature of the exhaust gas,
wherein the deterioration determination section is configured to disable determination of whether the first cell has deteriorated upon the temperature of the exhaust gas being less than a predetermined lower limit temperature or more than a predetermined upper limit temperature.

14. The control device according to claim 1, further comprising:
an air-fuel ratio acquisition section configured to acquire an air-fuel ratio of the exhaust gas,
wherein the deterioration determination section is configured to execute determination of whether the first cell has deteriorated only upon the air-fuel ratio of the exhaust gas being leaner than a theoretical air-fuel ratio.

15. A control device for an exhaust gas sensor that includes a first cell that discharges oxygen from an exhaust gas from an internal combustion engine, and a second cell that outputs a signal having a magnitude depending on a concentration of residual oxygen contained in the exhaust gas from which the oxygen has been discharged, the control device comprising:
a memory; and
a processor communicable with the memory,
the processor being configured to:
determine whether the magnitude of the signal outputted from the second cell has exceeded a threshold to thereby determine whether the first cell has deteriorated; and
variably set the threshold depending on a concentration of the oxygen in the exhaust gas.
